(19) United States
(12) Patent Application Publication
(10) Pub. No.: US 2008/0024088 A1
(43) Pub. Date: Jan. 31, 2008

(54) METHOD AND SYSTEM FOR BATTERY CHARGE FOR POINT-OF-SERVICE TERMINAL

(75) Inventor: Chris Henry, Phoenix, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: HYPERCOM CORPORATION, Phoenix, AZ (US)

(21) Appl. No.: 11/736,462

(22) Filed: Apr. 17, 2007

Related U.S. Application Data
(60) Provisional application No. 60/792,805, filed on Apr. 17, 2006.

(51) Int. Cl. H02J 7/00

(52) U.S. Cl. 320/115; 235/380

(57) ABSTRACT

The present invention provides for a method and system for simultaneously charging the battery of a portable POS terminal and its peripherals, either through the use of electrical connections on a charging dock or via a USB connection. The POS terminal also accommodates contactless instrument readers and optionally includes features for electronic signature capture, user display interaction, multi-tasking capabilities, check reading and age and identity verification.

### CROSS-REFERENCE TO RELATED APPLICATION

This application claims priority to and benefit of U.S. Provisional Application No. 60/792,805, entitled “Method and System for Battery Charge for Point-of-Sale Terminal” and filed on Apr. 17, 2006, which is hereby incorporated by reference in its entirety.

### FIELD OF INVENTION

The present invention relates, generally, to point of service (“POS”) terminals, and more particularly to a method and system for battery charge for POS terminals. BACKGROUND OF THE INVENTION

Point of service (“POS”) terminals enable convenient electronic payment for many products and services. Consumers holding cards associated with a charge, credit, debit, or loyalty account may pay for a purchase simply by using the card with a POS terminal located at stores, restaurants, and other locations where the products and services are being purchased. In order to have a portable POS terminal, it is necessary to use a battery to power the POS terminal as it is carried or otherwise used in a portable fashion. When the battery depletes its charge, it is necessary to re-charge the battery, or replace it, so that it is possible to continue using the POS terminal. When the POS terminal is used with peripherals, such as a printer, it may be necessary to also charge the peripherals. Presently, the POS terminal and the printer, or other peripheral, must be charged separately, in a time consuming manner.

Accordingly, it is desirable to create a battery charging system that will facilitate charging a POS terminal, and its peripherals, in a convenient fashion, in order to support a portable, handheld POS terminal with printer or other peripheral.

### SUMMARY OF THE INVENTION

The present invention facilitates a portable, hand-held POS terminal, with peripherals, by providing a convenient charging system that utilizes either electrical connection on a charging dock or utilizes a USB connection.

Other features of various embodiments of the present invention may include or support electronic signature capture, an interactive screen, multi-tasking capabilities, age and identity verification, program or account enrollment, account status and balance inquiries, payroll and government check reading, and medical or other insurance claim transactions. The present invention may be used with various types of accounts including credit, debit, charge, and loyalty programs and may also accommodate payment by promotion or gift cards, prepaid cards, payroll checks and government checks.

### BRIEF DESCRIPTION OF THE DRAWINGS

Additional aspects of the present invention will become evident upon reviewing the non-limiting embodiments described in the specification and the claims taken in conjunction with the accompanying figures, wherein like reference numerals denote like elements, and

FIG. 1 is a perspective view of an exemplary charging dock in accordance with an embodiment of the present invention;

FIG. 2 is a top view of the exemplary charging dock of FIG. 1;

FIG. 3 is a bottom view of the exemplary charging dock of FIG. 1;

FIG. 4 is a left view of the exemplary charging dock of FIG. 1;

FIG. 5 is a right view of the exemplary charging dock of FIG. 1;

FIG. 6 is a back view of the exemplary charging dock of FIG. 1;

FIG. 7 is a front view of the exemplary charging dock of FIG. 1;

FIG. 8 is a perspective view of an exemplary POS terminal according to. one embodiment of the present invention;

FIG. 9 is a top view of the exemplary POS terminal of FIG. 1; and

FIG. 10 is a flowchart diagram of an exemplary battery charge method in accordance with an embodiment of the present invention.

### DETAILED DESCRIPTION

The detailed description of exemplary embodiments of the invention herein makes reference to the accompanying drawings, which show exemplary embodiments by way of illustration and the best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the system (and components of the individual operating components of the system) may not be described in detail herein. It should be noted that many alternative or additional functional relationships or physical connections may be present in a practical system.

A point of sale (“POS”) terminal according to various embodiments of the present invention includes a card reader, a printer, various electronic circuits for processing a financial transaction, a display for presenting and optionally receiving input of transaction information, a keypad including numeric and function keys, and a housing containing the circuits, display and keypad. The printer may be housed within the POS terminal or the printer may be housed external to the POS terminal. The POS terminal may also be used with a contactless card reader, bar card reader, biometric reader, or other input devices, and thus may provide for a variety of interfaces. Wireless capabilities may also be incorporated into the present invention to promote portability. Other periphery devices for use with the POS terminal may include additional displays, PIN entry pads, alphanumeric keyboards, voice prompt systems, and signature capture devices. The POS terminal may be a stand alone unit or may be integrated into an electronic cash register (“ECR”), vending machine or a self check-out kiosk and the like.

In an exemplary POS transaction, the POS terminal facilitates payments by extracting account information from a user's transaction instrument (e.g., when a user swipes a credit card or inserts a smart card), receiving authentication input, constructing an authorization message, and communicating the authorization message to a host computer to authorize a financial transaction. As used herein, the term “user” includes a consumer, cardholder, merchant, and merchant temporarily in possession of a consumer's transaction card. Cardholder authentication may be accomplished using a PIN number, signature, voice command, biometric input, encrypted transaction instrument data, or any other suitable input. The host computer performs normal authorization procedures and returns one of an authorization and a rejection message. In performing an “on-line” transaction, after the transaction is consummated, the POS terminal communicates the relevant details of the transaction to be stored on the host computer system.

While in performing an “off-Line” transaction, the terminal may approve or decline based on tables or card date or other data, and later forward transaction data to the payment manager host computer. At the end of a transaction, the terminal may print a receipt utilizing the printer that is either housed internally within the POS terminal or housed external to the POS terminal. The POS terminal further communicates with the payment manager host computer to reconcile accounts at the end of a predetermined business cycle (e.g., at the end of each day).

Communications between the POS terminal and a host computer may be conducted over any suitable network now known or later developed. As used herein, the term “network” shall include any electronic communications means which incorporates both hardware and software components of such. Exemplary networks or communication channels include a telephone network, an extranet, an intranet, Internet, online communications, satellite communications, off-line communications, wireless communications, transponder communications, local area network (LAN), wide area network (WAN), networked or linked devices, and/or any suitable communication or data input modality.

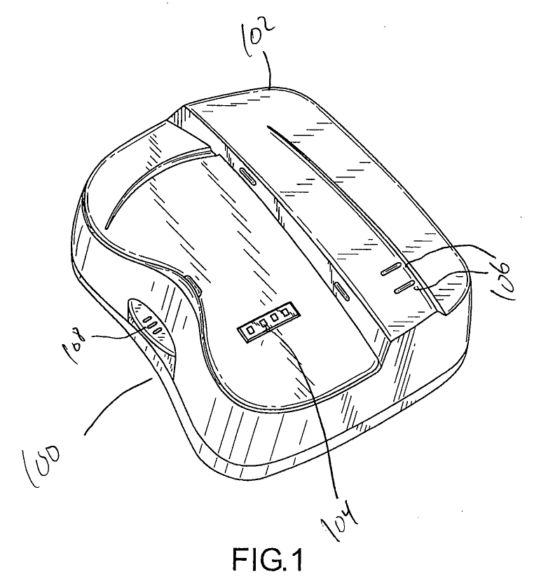

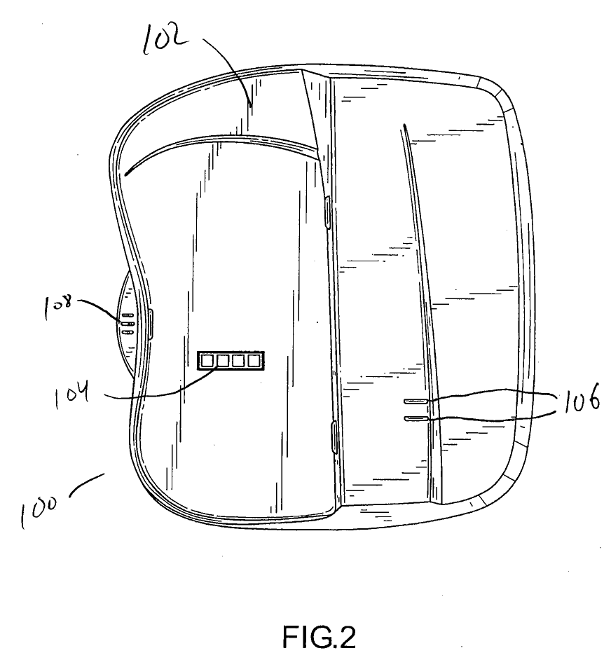

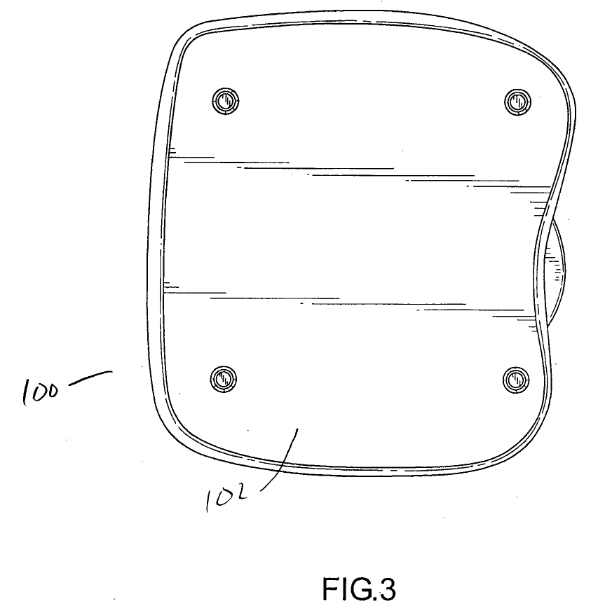

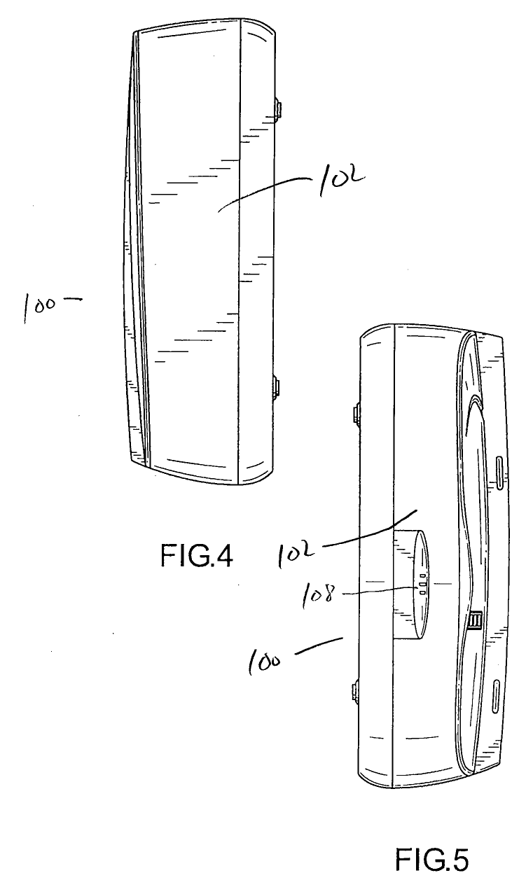

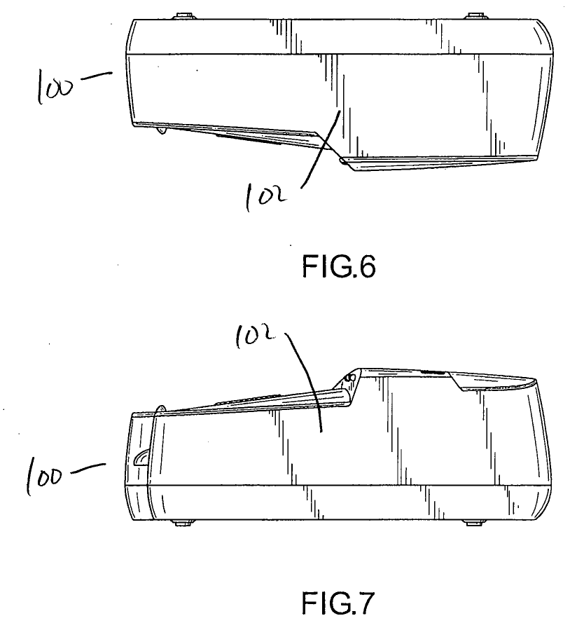

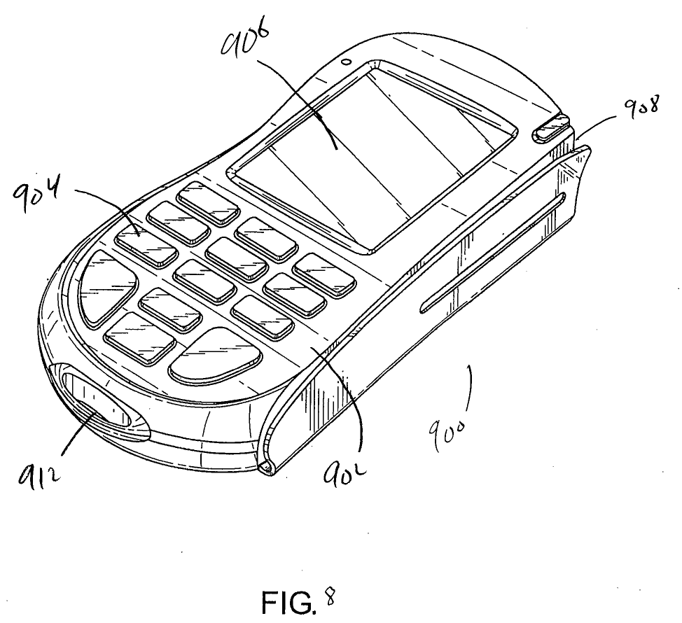

Referring now to FIGS. 1-7, an exemplary embodiment of a charging dock in accordance with the present invention is illustrated including a charging dock 100 having a housing 102, an electrical connection 104, power charging LED indicators 106, and release tab 108. Electrical connection 104 may be used for charging a POS terminal that is brought into connection with electrical connection 104. Housing 102 houses various components of charging dock 100 including basic components not shown here, such as a power supply circuit, and a microcontroller or microprocessor.

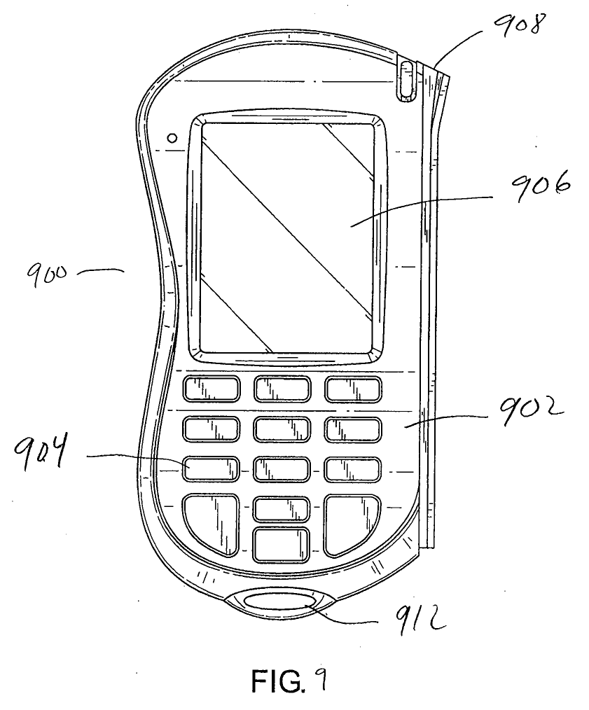

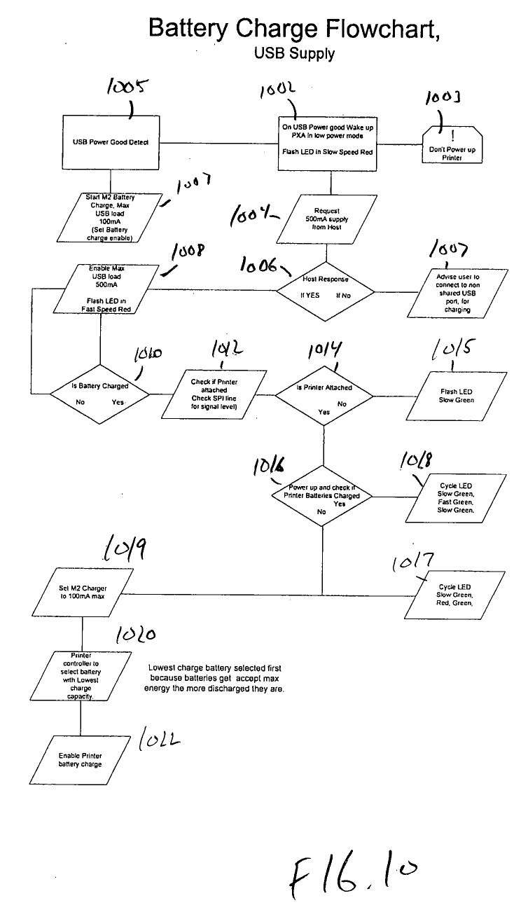

Referring now to FIGS. 8 and 9, an exemplary embodiment of a POS terminal in accordance with the present invention is illustrated including a POS terminal 900 having a housing 902, a key pad 904, an interactive display 906, and a magnetic card track 908. Housing 902 houses various components of POS terminal 900 including basic components not shown here, such as a power supply circuit, internal clock, microcontroller or microprocessor, ROM, RAM, lights, and other suitable hardware for communicating with a host computer, and inputting, processing, transferring or displaying transaction data.

Housing 902 includes magnetic card track 908 formed therein. Other embodiments of the present invention may utilize smart card readers and/or contactless card readers. Track 908 includes two sidewalls for guiding a user's transaction card to facilitate extraction of card data from a magnetic stripe on the card.

In accordance with one embodiment of the present invention, POS terminal 900 may be positioned on top of charging dock 100. Release tab 108 is used to release POS terminal 900 from charging dock 100. In accordance with one aspect of this embodiment, contacts 106 may be used to provide an electrical charge to POS terminal 900 such that the terminal's batteries may be charged. In an alternative embodiment, a USB connection may be used to charge the battery of POS terminal, and a peripheral such as a printer, in accordance with the method illustrated in FIG. 10. It will be appreciated that in this manner, the battery for the POS terminal and the battery for a peripheral device, such as a printer, may be charged via one USB connection. For example, the POS terminal may first be charged up to 500 milli-amps, and then it will only take 100 milli-amps from the USB port, while the printer may be charged from a 400 milli-amp charge. In accordance with one aspect of the present invention, a pin in the connection for the POS terminal or docking station may be used to indicate if the device is plugged into a USB connection or into another source such as a wall outlet.

In accordance with various aspect of the present invention, POS terminal 900 and one or more peripherals, such as a printer, may be connected in a stackable manner on docking station 100.

In operation, power charging LED indicators of POS terminal 900 may be used to indicate the charging status of POS terminal 900. For example, a flashing red light may indicate that the POS terminal and/or peripheral are not charging. An orange light (or other color) may indicate that the POS terminal and/or peripheral are charging. A green light (or other color) may indicate that the POS terminal and/or peripheral are fully charged. In accordance with other aspects of this embodiment of the present invention, a first flash may be used to indicate the charging status of the POS terminal, and a second flash may be used to indicate the charging status of a peripheral, such as a printer.

In accordance with an alternative embodiment of the present invention, a vehicle adapter may be used to connect docking station 100 to a power source in a vehicle for charging POS terminal 900 and one or more peripherals.

In accordance with one embodiment of the present invention, a personal computer or other computing device may be used to negotiate a battery charge for a POS terminal and/or peripherals via a USB connection, by going straight up to 500 milli-amps. In accordance with another embodiment of the present invention, a wall outlet may be used to provide a battery charge for the POS terminal and/or peripherals by powering straight up to 500 milli-amps. In accordance with another embodiment of the present invention, a docking station may be used to battery charge both a POS terminal and one or more peripherals at the same time by charging up to 800 milli-amps.

Housing 902 may include a lanyard opening 912 for connecting a lanyard or similar cord to housing 902. In this manner, a user may carry the POS terminal on their belt, backpack, and the like. In accordance with one embodiment of the present invention, housings 102 and 902 may comprise a zinc alloy chassis, resulting in a highly portable, compact POS terminal and printer. In addition, modular or peripheral devices may connect to housings 102 and 902, either via a socket or through a wireless connection (not illustrated). Exemplary modular peripheral devices include printers, contactless transaction instrument readers, radio frequency readers, infrared and wireless communications devices, supplemental magnetic stripe readers, PIN keypads, bar code scanners, printers, modems, telephone handsets, biometric scanners, voice command input devices and the like. Similarly, any peripheral device or capability now known or later developed may be integrated into or associated with POS terminal 900. Additionally, housing 902 may include features such as a latch, clip, or slot to facilitate docking, tabletop, pedestal or stand mounting.

Keypad 904 comprises an alphanumeric keypad including keys numbered zero through nine for entry of PIN numbers. Keypad 904 may also include any number of function keys, such as, for example, keys for canceling a transaction, specifying the type of transaction instrument, selecting whether to print a receipt, confirming a charge amount, or for any other relevant feature. Alphanumeric and/or function keys on keypad 904 may be separately movable as with a conventional keyboard, or may be displayed on an interactive surface that responds to pressure, static, or any other suitable user input or action. In accordance with one embodiment of the present invention, keypad 904 is integrated into interactive display 906 as a series of on-screen interactive icons. Exemplary function keys or icons include: cancel, enter, clear, print, reset, power, debit, credit, cash back, additional transaction selection, preset dollar amounts for cash back, and the like.

With continued reference to the embodiment shown in FIG. 9, interactive display 906 serves to display transaction information and with an optional touch screen, may also receive user input such as a customer's signature. Various embodiments include electronic signature capture, enabling user's to electronically authorize a transaction by passing a stylus or pen over the display much the same as signing a conventional paper receipt. Replaceable screen protectors protect display 906 from wear by the stylus. Display 906 may present advertising or interactive messages such flashing or moving messages notifying users of merchant membership programs, sales, upcoming events and the like. In alternative embodiments, display 906 is not interactive but merely displays transaction data while providing no signature capture, interactive icons or other on-screen user input capabilities. In additional alternative embodiments, POS terminal 900 does not include any type of display 906, for example, when POS terminal 900 is coupled to a cash register including a display. Alternatively, a stand alone POS terminal 900 need not have any form of display 906 to facilitate a transaction.

In one embodiment of the invention, a transceiver disposed in POS terminal 900 and associated programming modules support wireless communication between POS terminal 900 and a host computer. This wireless communication enables the POS terminal to be portable and even held in a user's hand. The user can carry the POS terminal with them as they carry out their business.

One embodiment of the invention supports age and identity verification by extracting user data from a user's transaction instrument, requesting authentication input, and verifying the user data and authentication input with user data stored on the host system of the transaction instrument issuer. Age and identity verification may likewise be performed using any appropriate transaction instrument data, host system data or user supplied data.

One embodiment of the invention supports payroll check and government check reading and/or cashing. For example, the POS terminal facilitates the capture of routing and account numbers, and any other relevant information from bar codes or other machine readable indicia printed or otherwise accessible on such checks. Thus, a consumer may present such checks for immediate electronic verification and drawing of funds from the check issuer's account for use in payment at a POS terminal. In embodiments that include a cash return device, a consumer may receive any remaining balance of the check value as cash.

In one embodiment of the invention, IP and/or USB ports enable connectivity of the POS terminal with a docking station, printer device, keyboard, personal computer, or with additional POS terminals. Additionally, the POS terminal may support both Ethernet and modem connectivity capabilities. Redundant communications connectivity capabilities serve to reduce or eliminate the impact of temporary network failures by automatically reestablishing communications with a host system using a backup communications channel. For example, if a local internet network hub fails, the POS automatically dials the appropriate host system using a back-up modem. Additional wireless communication capabilities enable portable use of the POS terminal. For example, a salesperson may carry a wireless POS terminal on his or her belt for assisting customer's with showroom purchases without the need to relocate to a cashier's desk

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. The scope of the present invention is accordingly to be limited by nothing other than the appended claims, in which reference to an element in the singular is not intended to mean “one and only one” unless explicitly so stated, but rather “one or more.” Further, no element described herein is required for the practice of the invention unless expressly described as “essential” or “critical.”

What is claimed is:

1. A charging dock assembly for charging a battery of a point-of-service terminal, the charging dock assembly comprising:
a housing;
an electrical connection positioned on the housing, wherein the electrical connection is configured to interface with the point-of-service terminal;
an LED indicator positioned on the housing, wherein the LED indicator is configured to indicate a charging status of the point-of-service terminal; and
a release tab positioned on the housing, wherein the release tab is configured to release the point-of-service terminal from the charging dock.
